(19) United States
(12) Patent Application Publication
(10) Pub. No.: US 2008/0291053 A1
(43) Pub. Date: Nov. 27, 2008

(54) Signal-operable traffic sign assembly

(76) Inventor: Jerry L. O'Brien, Trout Valley, IL (US)

Correspondence Address: Meroni & Meroni, P.C.;Charles F. Meroni, Jr., P.O. Box 309, Barrington, IL, 60011, US

(21) Appl. No.: 11/805,433

(22) Filed: May 23, 2007

(51) Int. Cl. G08G 1/095

(52) U.S. Cl. 340/907

(57) ABSTRACT

A traffic sign assembly messages onlookers when activated by a power loss signal. The assembly comprises a bifurcated sign, a J-shaped bracket member, a stem pinion or shaft, a linear actuator with pinion track, and circuitry for signaling the actuator. The bifurcated sign comprises top and bottom sign portions, and front and back messaging surfaces. The bracket member comprises opposing bracket ends attached to the top and bottom sign portions. The stem pinion comprises bracket and track-engaging portions. The pinion track cooperates with the track-engaging portion for effecting rotation of the bracket member via the bracket-engaging portion when a power loss or gain signal is sent to the actuator. The rotating bracket-pinion assembly functions to unfold the top sign portion for exposing a primary message. The back surface may comprise secondary indicia for messaging onlookers with a secondary message when the sign is a normally dormant, folded state.

### BACKGROUND OF THE INVENTION

1. Technical Field

The present invention generally relates to a supplemental visual sign display for a traffic signal. More particularly, the present invention relates to a traffic sign, activated by the loss of power to an accompanying, otherwise power-driven traffic signal.

2. Description of the Prior Art

Power-driven signal lights and signaling systems for governing traffic are well known in the arts. Being power driven, these signaling systems are periodically subject to failure in view of power loss from their electrical power source. Governance of the target traffic streams thus becomes handicapped as a result of power losses, and the personal safety of vehicular occupants becomes as risk given periodic power outages. As many have noted, it is desirable to have back-up traffic control means, which means may remain fully functional in the event that traditional traffic lights cease to function upon power interruption. Bearing these and similar other notions in mind, certain attempts have been made to provide simple and effective means for providing back-up traffic signaling means or signage that become activated or actuated in the event of a power loss at an otherwise power-driven and signal-controlled roadway. Some of the more pertinent prior art relating to power loss activated traffic signs and the like are briefly described hereinafter.

U.S. Pat. No. 1,326,009 ('009 patent), which issued to Wetter, discloses a Signal Apparatus. The '009 patent teaches a signaling apparatus employing a particular kind of semaphore or target which may be used as a stationary traffic signal or mounted on a vehicle or common carrier, the semaphore in each instance retaining its dominating features and similarity so that the pedestrians and drivers will recognize the semaphore irrespective of its application or installation. Thus one will be more easily guided by such a signal and having seen it used as a traffic signal in locality which would readily recognize it and obey it when used as an automobile direction signal in another locality. Notably, the signal apparatus is selectively collapsible for enabling traffic control as needed.

U.S. Pat. No. 3,863,214 ('214 patent), which issued to Kerry, Jr., discloses a Supplemental Visual Display for Traffic Signal. The '214 patent teaches a supplemental visual display cooperable with a traffic signal for indicating the operational mode thereof. An arm supporting a visual display at one end is raised by an electric motor in response to an electric signal from the traffic signal controller and, thereafter, is normally retained in the upright position by an electromagnet. When the electromagnet is relaxed, in accordance with one operational mode of the controller, the arm pivots downwardly to exhibit the visual display.

U.S. Pat. No. 4,642,605 ('605 patent), which issued to Karp, discloses a Power Failure Responsive Warning Device. The '605 patent teaches a warning device which is responsive to the failure of an electric power supply for activation to a warning mode. The warning device includes an arm pivotally mounted to a frame member and latched by an electromagnet in a non-warning mode. In the non-warning mode, a collapsible warning sign carrier is enclosed within an enclosure formed by the frame and the arm. When the supply of power is interrupted, the electromagnet releases the arm so that the arm pivots to a warning position.

U.S. Pat. No. 6,956,502 ('502 patent), which issued to Bartinelli, discloses a Traffic Control Sign. The '502 patent teaches a traffic control sign that automatically unfolds and displays the message STOP and displays flashing messages SIGNAL OUT and 4 WAY upon power failure to traditional traffic lights. The traffic control sign includes a pair of sign plates hingedly attached by a pair of hinges. An enfolding assembly is utilized to rotatably enfold and electromagnetically hold the pair of sign plates to a folded position upon resumption of power. The traffic control sign is adapted to be mounted to existing cable or a circular pipe component used for related traditional traffic signal fixtures.

The prior art further teaches a variety of traffic governing signs that activate or actuate upon detection of a power loss signal. The prior art appears to be silent, however, on a power loss activated sign comprising linear actuation means for pinion-actuating an otherwise dormant, folded sign to a messaging, unfolded configuration. The prior art thus perceives a need for such an apparatus; and an attempt to meet this need is embodied by the teachings of the present invention. While not limited thereto in its utility, the present invention is particularly well suited for use in combination with conventional electrically powered traffic signals.

### SUMMARY OF THE INVENTION

Accordingly, it is primary object of the present invention to provide traffic controlling or governing signage that may be activated upon the receipt or detection of a power loss to accompanying, normally power-driven traffic signals. It is contemplated that the sign may well operate either via wired communications or via wireless communications, and may comprise both primary and secondary traffic-controlling messages depending on whether the sign is dormant or actuated. It is further contemplated that the traffic sign of the present invention may operate in conjunction with state of the art emergency vehicle signaling means at signal-controlled intersection such that the sign may be selectively activated for bolstering traffic signals when activated by approaching emergency vehicles and the like.

To achieve these and other readily apparent objectives, the present invention essentially provides a traffic sign assembly, which traffic sign assembly is unfoldable when activated by a power loss signal for messaging onlookers. The traffic sign assembly of the present invention essentially comprises a bifurcated sign assembly, a J-shaped bracket member, a shaft, a linear actuator, actuator-signaling means, and an assembly-contained or self-contained power source, as most readily or practically defined by an electrochemical battery.

The bifurcated sign assembly comprises a top sign portion, a bottom sign portion, an anterior messaging surface, a posterior interfacing surface, and certain hinge means for effecting a sign axis of rotation intermediate the top and bottom sign portions. A carriage track may be preferably attached to the top sign portion at the posterior interfacing surface for receiving an outfitted first end of the J-shaped bracket member. The J-shaped bracket member comprises a head end defining the outfitted first end and a hooked end opposite the head end. The head end comprises or is outfitted with certain roller means for movement, which means are cooperatively associated with the carriage track (attached to the top sign portion at the posterior surface) for track-guiding roller movement of the head end. The hooked end of the bracket member comprises a shaft-receiving or pinion-engaging structure.

The shaft comprises a bracket attachment end and a pinion end and may be alternatively defined as a stem pinion. The bracket attachment end is coaxially received by, and fastened to the shaft-receiving structure thereby forming a shaft-bracket assembly, which shaft-bracket assembly has a uniform assembly axis of rotation. The linear actuator comprises a linearly actuable pinion track and signal-receiving means for receiving a track-actuating or switch-closing signal. The shaft and linear actuator are attached to the posterior surface of the bottom sign portion via certain housing means, which means may comprise a bracket-receiving slot for enabling the bracket member to extend from the bottom sign portion to the top sign portion.

The actuator-signaling means function to selectively signal the linear actuator via the signal-receiving means. To achieve this essential function, it is contemplated that the actuator-signaling means may essentially comprise certain signal-detection means for detecting various signals, including power loss signals and power gain signals. The assembly-contained power source is in electrical communication with the linear actuator and the actuator-signaling means for enabling wire-directed or wireless linear actuation of the pinion track in a first direction when a power loss signal is detected by the signal-detection means and for enabling linear actuation of the pinion track in a second, opposite direction when a power gain signal is detected by the signal-detection means.

The linear actuated pinion track is cooperable with the pinion end of the shaft for rotating the shaft-bracket assembly about the assembly axis of rotation. The rotating shaft-bracket assembly functions to raise the top sign portion via the bracket member and track-guided roller movement of its head end. The raised top sign portion thereby unfolds from a non-actuated folded state about the sign axis of rotation for exposing the anterior messaging surface, which surface comprises certain primary indicia for messaging onlookers with a primary message. The posterior or interfacing surface may further comprise certain secondary indicia for messaging onlookers with a secondary message when the sign is a normally dormant, folded state.

### BRIEF DESCRIPTION OF THE DRAWINGS

Other features of my invention will become more evident from a consideration of the following brief description of patent drawings:

FIG. 1 is an anterior plan view of the traffic sign assembly of the present invention in an unfolded, activated state.

FIG. 2 is a fragmentary posterior plan view of a first preferred traffic sign assembly according to the present invention in an unfolded, activated state, with certain parts of a housing removed to show otherwise hidden structure.

FIG. 3 is a fragmentary posterior plan view of the first preferred traffic sign assembly otherwise shown in FIG. 2 in a folded, dormant state.

FIG. 4 is a fragmentary enlarged posterior plan view of the linkage zone intermediate the top sign portion and the bottom sign portion with certain portions of the sign actuation structures being highlighted.

FIG. 5(a) is a side plan view of the traffic sign assembly of the present invention in a folded, dormant state.

FIG. 5(b) is a side plan view of the traffic sign assembly of the present invention in an unfolded, activated state, with an enlarged fragmentary perspective view of the head end of the bracket member linkage.

FIG. 6 is a diagrammatic depiction of the traffic sign assembly as viewed laterally and actuating from a folded, dormant state to an unfolded, activated state.

FIG. 7 is a circuit diagram of the essential circuitry directing power and signals according to the traffic sign assembly of the present invention.

FIG. 8 is a fragmentary posterior plan view of a second preferred traffic sign assembly of the present invention in a folded, dormant state.

FIG. 9 is a posterior plan view of the second preferred traffic sign assembly according otherwise shown in FIG. 9 in an unfolded, activated state, with certain parts of a housing removed to show otherwise hidden structure.

FIG. 10 is a fragmentary perspective view of an intersection outfitted with power-driven traffic signals and a traffic sign assembly according to the present invention in a folded, dormant state.

FIG. 11 is a fragmentary perspective view of the intersection otherwise shown in FIG. 10 wherein a power loss has occurred thereby activating the traffic sign assembly according to the present invention to an unfolded, activated state.

FIG. 12 is a fragmentary perspective view of the intersection otherwise shown in FIG. 10 wherein an emergency vehicle has signal-interrupted normal traffic signal operation thereby activating the traffic sign assembly according to the present invention to an unfolded, activated state.

### DETAILED DESCRIPTION OF THE PREFERRED EMBODIMENT(S)

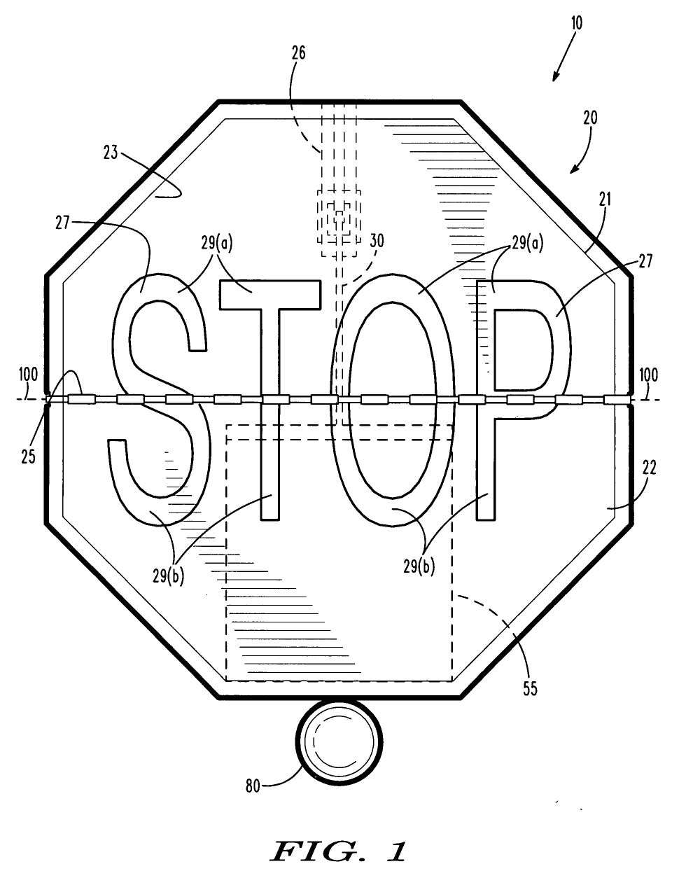

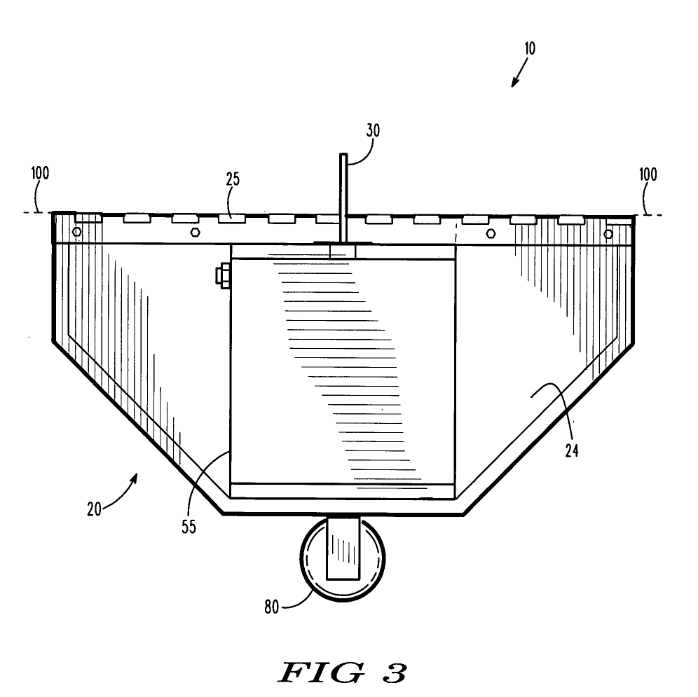

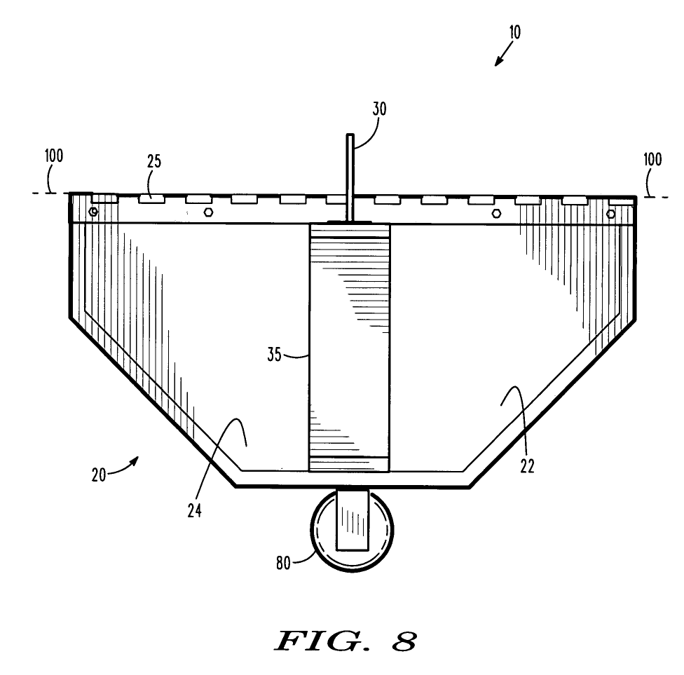

Referring now to the drawings with more specificity, the preferred embodiment of the present invention generally concerns a traffic sign assembly 10 as generally illustrated and referenced in FIGS. 1-3, 5-6, and 8-12. It is contemplated that the traffic sign assembly 10 of the present invention resides in a normally relaxed or dormant folded state as generally depicted in FIGS. 3, 5(a), 8, and 10. When actuated or activated by way of a power loss signal otherwise associated with power-driven traffic-governing signals 11, the traffic sign assembly 10 of the present invention is unfoldable so as to reveal a traffic governing message as generally depicted in FIGS. 1, 9, 11, and 12.

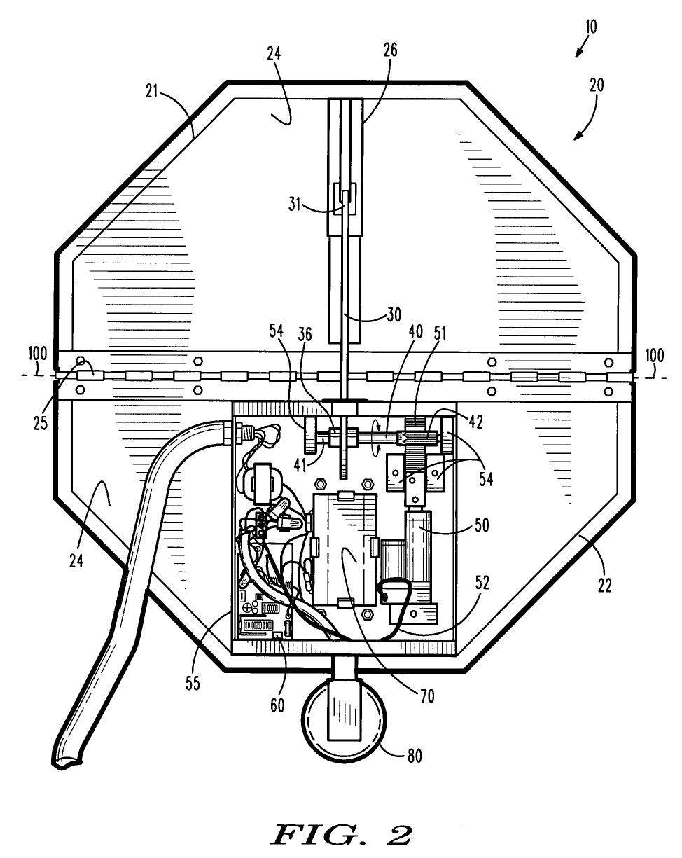

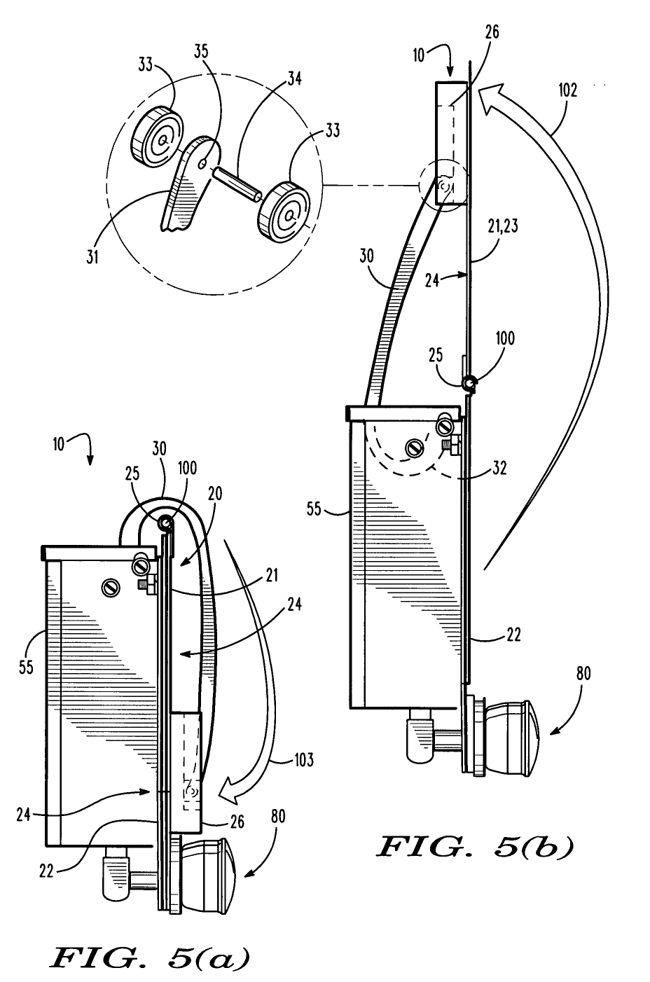

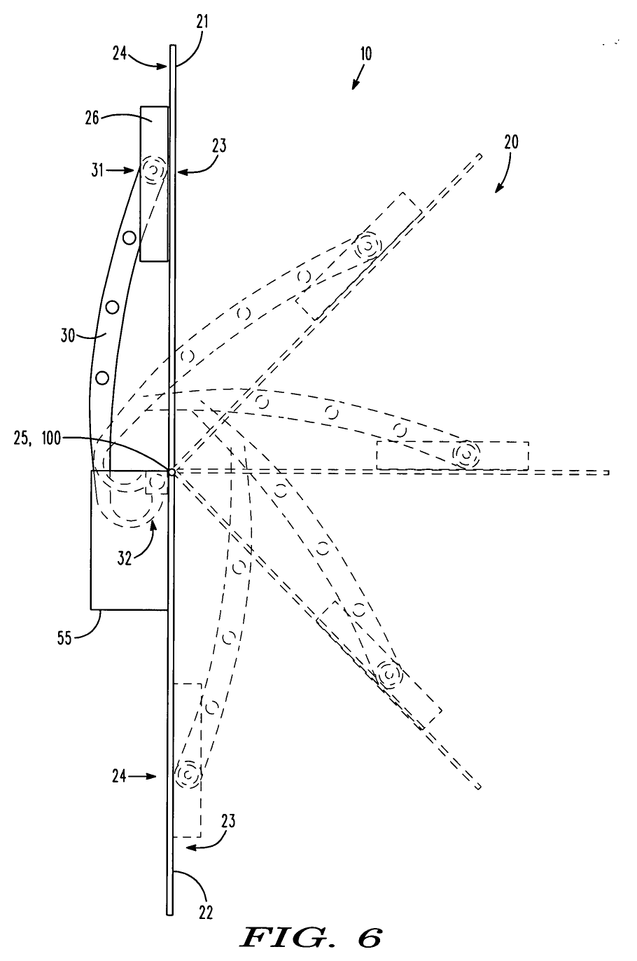

The traffic sign assembly 10 is further depicted in an actuated, unfolded state in FIGS. 2, 4, and 5(b) without particular illustrative attention being given to the traffic-governing message. The traffic-governing message “STOP” is being illustrated either in whole or part throughout FIGS. 1, 3, 8, 9, 11, and 12 as an exemplary message. Naturally other types of messages, including non-textual, symbolic messages may be borne by the sign assembly 10. FIG. 6 attempts to illustrate the unfolding process from a lateral viewpoint as comparable to (1) the extreme folded state depicted in FIG. 5(a) and (2) the extreme unfolded state depicted in FIG. 5(b).

A first preferred embodiment of the traffic sign assembly 10 of the present invention preferably and essentially comprises a bifurcated sign assembly 20; a J-shaped bracket member 30; a shaft 40; a linear actuating assembly 50; certain actuator-signaling means 60; and an assembly-contained power source 70. The bifurcated sign assembly 20 essentially comprises a top sign portion 21 and a bottom sign portion 22 constructed from sturdy, weather-resistant materials for effectively supporting the display of a primary traffic-governing message via an anterior of front messaging surface 23, which anterior messaging surface 23 is generally depicted and referenced in FIGS. 1, 5(b), 6, 11, and 12.

Opposite the anterior messaging surface 23 is a posterior or back interfacing surface 24 to which the certain other elements of the assembly 10 attach or interface. The posterior interfacing surface 24 is generally depicted and referenced in FIGS. 2-6, and 8-10. The bifurcated sign assembly 20 further preferably comprises certain hinge means as may be defined by a piano type hinge assembly 25 for effecting a sign axis of rotation 100 intermediate the top sign portion 21 and the bottom sign portion 22 as further referenced and depicted. The top sign portion 21 preferably comprises or interfaces with a carriage track 26, which track 26 is attached to the interfacing surface 24 as generally depicted and referenced in FIGS. 1, 2, 4, 5(a), 5(b), 6, and 9.

The J-shaped bracket member 30 is generally depicted and referenced in FIGS. 1-6, 8, and 9. It may be seen from an inspection of the noted figures that the J-shaped bracket member 30 essentially comprises a head or first end 31 and a hooked or second end 32. The bracket member 30 is preferably constructed from substantially rigid, load-bearing material(s) for transmitting load along its length. FIG. 5(b) comprises an fragmentary, enlarged, exploded type view of the head end 31 in which it may be seen that the head end 31 preferably comprises certain roller means for movement, as may be defined by laterally opposed wheels 33 mountable on a shaft 34 extendable through an aperture 35 formed in the head end 31. The roller means for movement associated with the head end 31 are received in, or otherwise cooperatively associated with, the carriage track 26 for guiding roller movement of the head end 31 within the track 26. In other words, carriage track 26 functions to track-guide the head end 31 outfitted with the roller means for movement.

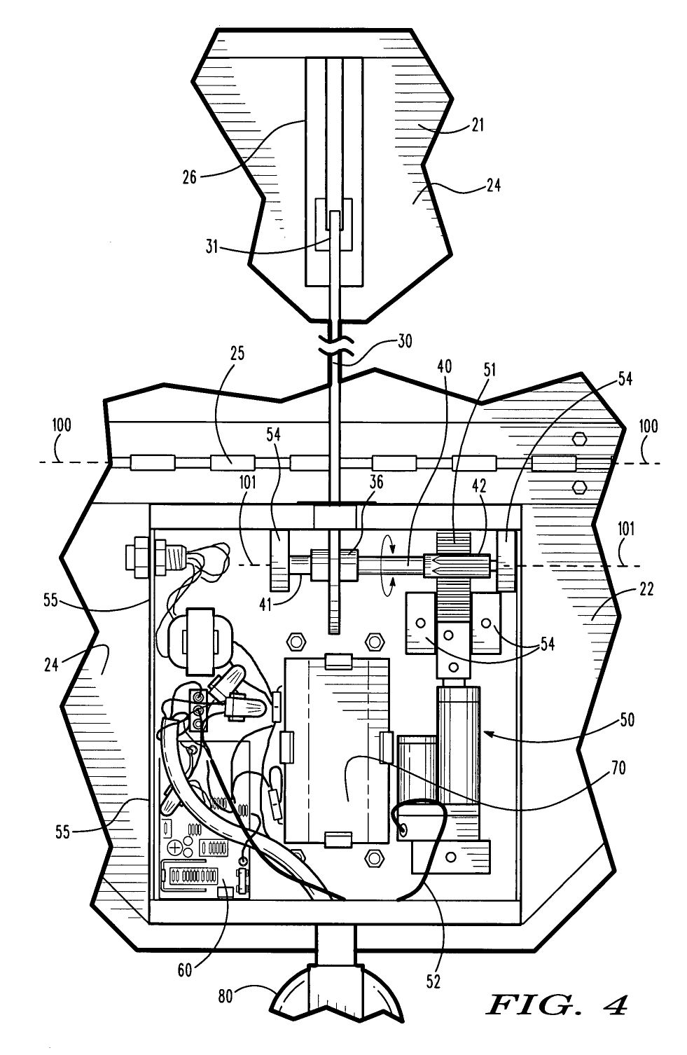

The hooked end 32 preferably comprises certain shaft-receiving or shaft-engaging structure 36, which structure 36 may preferably be defined by shaft-receiving tunnel or aperture, the inner diameter of which is slightly larger than the outer diameter of the shaft 40 such that the shaft 40 may be telescopically or coaxially received within and subsequently fixedly attached or fastened to the structure 36. The shaft 40, in a first preferred embodiment, preferably comprises a bracket attachment end 41 and a pinion end 42 as perhaps best seen in FIGS. 2 and 4. The bracket attachment end 41 is telescopically or coaxially received by the shaft-receiving structure 36 and, as fastened together, becomes an integral unit thus forming a shaft-bracket assembly. The shaft-bracket assembly has a uniform assembly axis of rotation 101 as referenced in FIG. 4. In other words, both the structure 36 and the shaft 40 rotate uniformly about the axis of rotation 101 when a torque extends therealong.

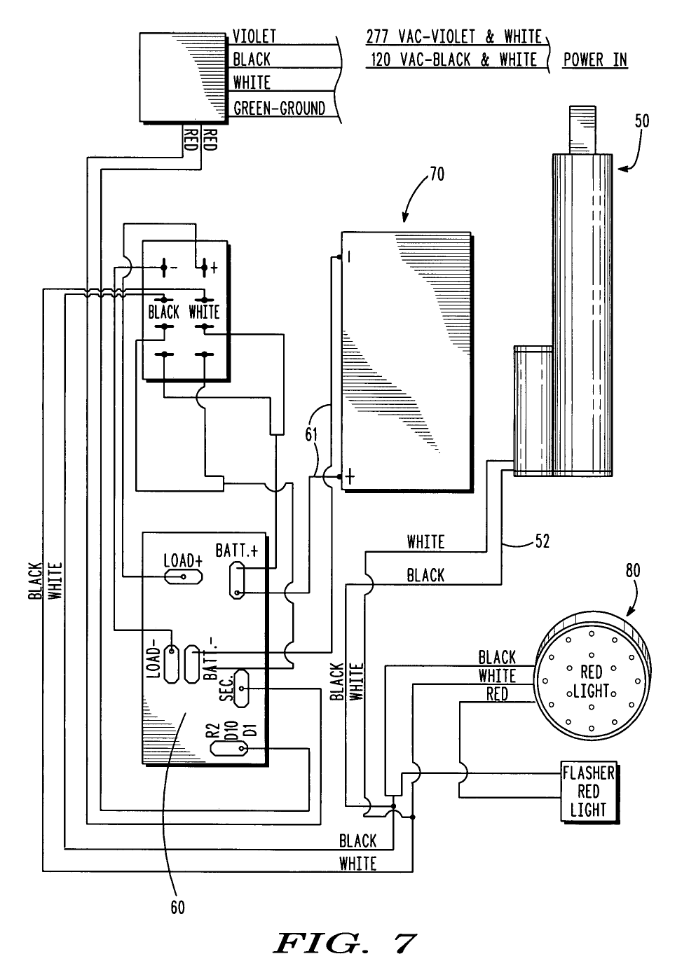

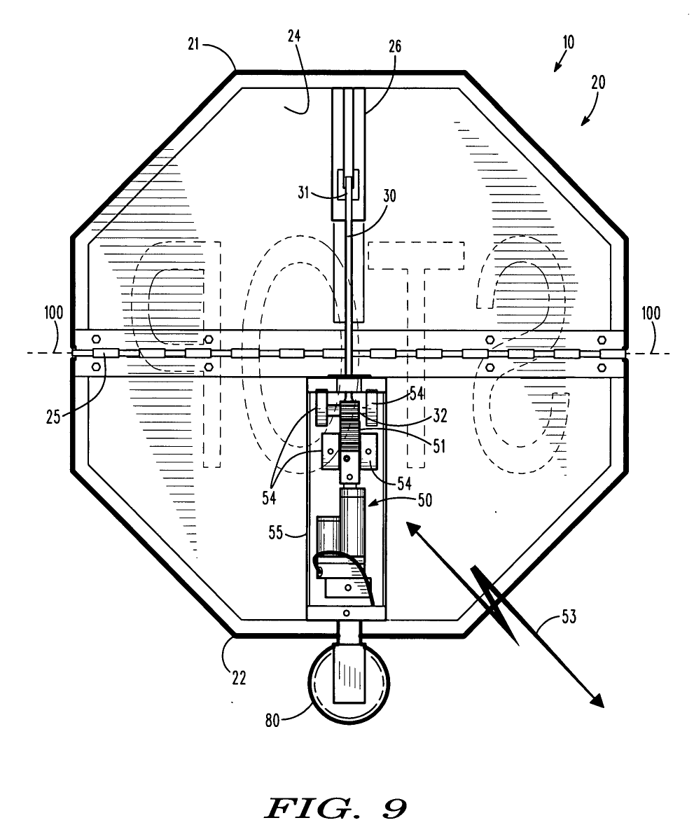

The linear-actuating assembly 50 preferably comprises an actuable pinion track 51 (as generally depicted and referenced in FIGS. 2, 4, and 9), and certain signal-receiving means for receiving a track-actuating signal, which signal may be delivered or transmitted to the linear actuating assembly 50 either via circuitry 52 as generally and comparatively depicted in FIGS. 2, 4, and 7; or wirelessly as symbolically depicted at 53 in FIGS. 9, 11, and 12. When a switch-closing signal is received, the linear actuating assembly 50 actuates the pinion track 51 outfitted with cooperative structure for engaging the pinion end 42, thereby imparting a torque to the shaft 40 and rotating the shaft 40 and structure 36 in a first rotational direction. Notably, the shaft 50 and linear actuator or linear actuating assembly 50 are attached to the bottom sign portion 22 via a block element (54)-outfitted housing 55, which housing 55 is attached to the interfacing surface 24, and the bracket member 30 extends from the bottom sign portion 22 to the top sign portion 21 bridging the sign axis of rotation 100.

It is contemplated that the actuator-signaling means may 60 be defined by certain circuitry as board-mounted for signaling the linear actuator 50 via the signal-receiving means as generally depicted and referenced in FIGS. 2, 4, and 7. In this regard, it is contemplated that the actuator-signaling means may preferably and essentially comprise certain signal-detection means for detecting various signals, including power loss signals (or absence of external power) and power gain signals (or presence of external power). In electrical communication (via certain circuitry 61) with the actuator-signaling means 60, as well as the linear-actuating assembly 50, is an assembly-contained power source 70 as depicted and referenced at 70 in FIGS. 2, 4, and 7.

The power source 70 may be preferably defined by a electrochemical battery and is in communication with the linear actuator 50 and the actuator-signaling means 60 for enabling linear actuation of the pinion track 51 in a first direction (as at arrow 102 in FIG. 5(b)) when a power loss signal is detected by the signal-detection means, and in a second direction opposite the first direction (as at arrow 103 in FIG. 5(a)) when a power gain signal is detected. The linear actuated pinion track 51 is cooperable with the pinion end 42 for rotating the shaft-bracket assembly about the assembly axis of rotation 101. The rotating shaft-bracket assembly functions to raise or unfold the top or first sign portion 21 via the bracket member 30 and the track-guided roller movement of the head end 31. The raised top sign portion 21 thereby unfolds from a non-actuated folded state about the sign axis of rotation 100 as generally depicted in FIG. 6 for exposing the anterior messaging surface 23 to onlookers. It is contemplated that the anterior messaging surface 23 may preferably comprise certain primary indicia 27 for messaging onlookers with a primary message as, for example, “STOP”.

Further, the actuator-signaling means may enable linear actuation of the pinion track 51 in the second direction opposite the first direction when a power gain signal is detected by the signal-detection means for refolding the top sign portion 21 to a folded state. Again, the linear actuated pinion track 51 being cooperable with the pinion end 42 for rotating the shaft-bracket assembly about the assembly axis of rotation 101, which rotation functions to lower the top sign portion 21 via the bracket member 30 and the track-guided roller movement of the head end 31. The lowered top sign portion 21 thus folds from an actuated, unfolded state about the sign axis of rotation 100 for otherwise concealing the anterior messaging surface 23.

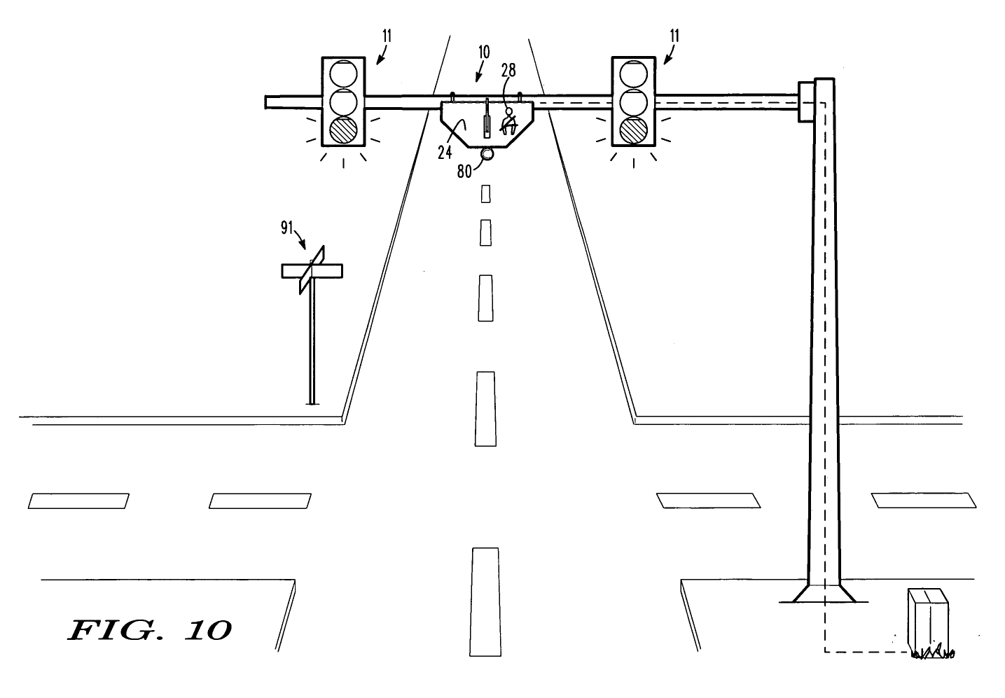

Notably, the top sign portion 21 may further preferably comprise certain secondary indicia 28 upon the interfacing surface 24 as generally depicted and referenced in FIG. 10. It may be seen from an inspection of FIG. 10 that the secondary indicia may comprise certain information that is generally useful for times when the sign is in a dormant, folded, or un-activated state (i.e. during those times that the power-driven traffic signals 11 are properly functioning). For example, it is contemplated that a message to buckle one's seat belt as at 28 in FIG. 10 is a generally applicable rule of the road and may well represent a universally applicable message during periods of sign dormancy.

As a means to enhance the effectiveness of the signage, it is contemplated that the primary indicia 27 may be cooperatively borne by the top and bottom sign portions 21 and 22 as generally depicted in FIG. 1. In other words, the top or first sign portion 21 might bear a top or first half of message indicia as at 29(a) and the bottom or second sign portion 22 might bear a bottom or second half of message indicia as at 29(b). Together the message indicia 29(a) and 29(b) cooperate to form a single message such as the illustrated message “STOP”. It is further contemplated that by providing such an arrangement, the usable surface area of the anterior messaging surface 23 is maximized thereby allowing enhanced sizing of the primary indicia 27, which enhanced (font) sizing may well function to enhance the primary message to message onlookers.

The traffic sign assembly 10 of the present invention may further comprise a light emitter 80 as well as certain light-signaling means for signaling or switching the light emitter 80. The light emitter 80 or light of the assembly 10 is generally depicted and referenced in FIGS. 1-5(b), and 7-12. The light emitter 80 and light-signaling means (as defined by circuitry of the actuator-signaling board) is also in communication with the power source 70 and the signal-detection means. It is contemplated that the light-signaling means preferably enables light emission (whether constant or periodic depending on the supporting circuitry) from the light emitter 80 when the power loss signal is detected by the signal-detection means, which power loss activated light emission may well function to drawing onlookers' attention toward the anterior messaging surface 23 for enhancing the overall effectiveness of the primary message to message onlookers.

While the above description contains much specificity, this specificity should not be construed as limitations on the scope of the invention, but rather as an exemplification of the invention. For example, the foregoing teachings may be said to further support a traffic sign assembly 10 comprising a light emitter 80 and associated light-signaling means whereby the light-signaling means enable light emission from the light emitter when a traffic-governing signal other than a power loss (off) or power gain (on) signal is received.

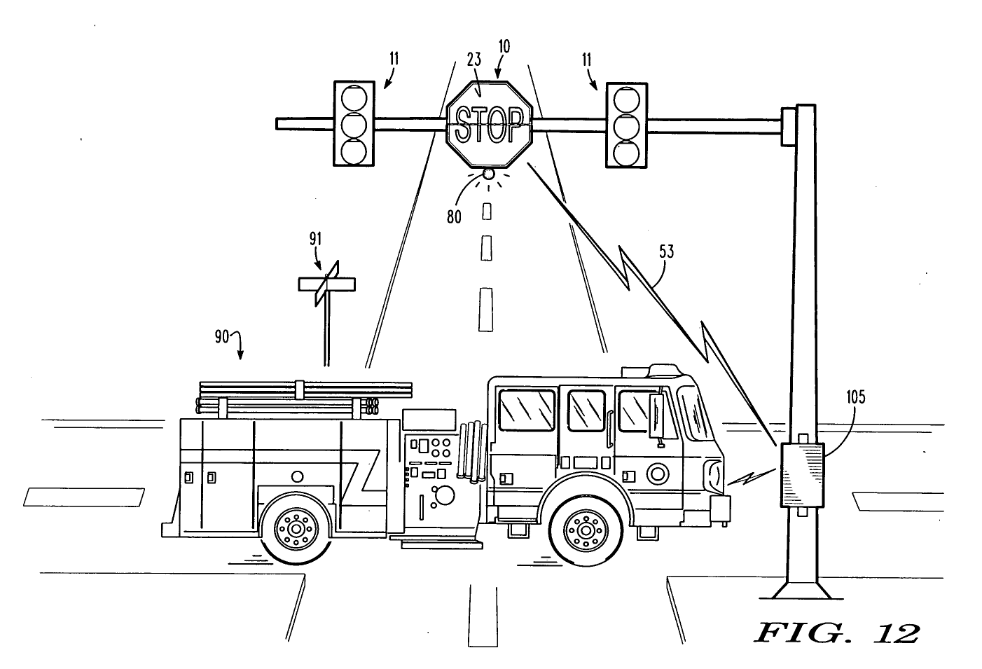

In this regard, it is contemplated that the light emitter 80 may well be signaled from an emergency vehicle 90 operator or the like as generally depicted in FIG. 12. Separate light emitters have become common at intersections 91 for signaling traffic at the intersection of the imminent approach of emergency vehicles 90 and the like. In this regard, it is contemplated that similar light emitters 80 may be incorporated into the traffic sign assembly 10 of the present invention for drawing onlookers' attention toward associated power-driven traffic signals 11 or the traffic sign assembly 10 whether or not a power loss occurs, and particularly at the prompt of an oncoming or approaching emergency vehicle 90.

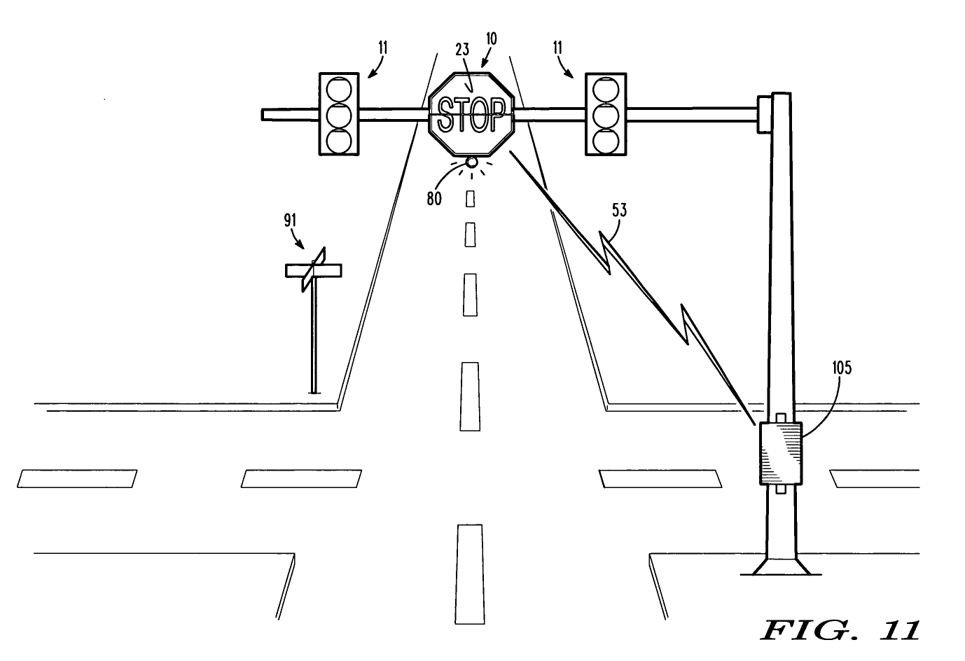

Further, it is contemplated that the shaft 40 according to the preferred embodiment may be abbreviated as generally depicted in FIG. 9 such that the linear actuation of the pinion track 51 is in line with pinion structure otherwise associated with the bracket member 30. Further, the actuator-signaling means or actuator-governing means may be in wireless communication with the linear actuating assembly 50 from a remote location 105 as generally depicted and referenced in FIGS. 11 and 12. In this regard, it is contemplated that the linear actuating assembly 50 may simply connected to a self-contained power source and remotely activated to either open or unfold the sign assembly 20 or close (fold) the sign assembly 20 depending on the underlying power state for the intersection signals 11.

The traffic sign assembly of the present invention is thus preferably unfoldable when activated by a power loss signal for messaging onlookers, and comprises a sign assembly (as at 20); a bracket member (as at 30); a pinion assembly (as perhaps defined by the linear actuator 50 or similar other gear or shaft or pinion assembly for moving gears relative to the geared portion of the bracket member or shaft-bracket assembly); certain assembly-signaling means (as at actuator-signaling means 60); and a power source (as at 70).

The sign assembly may be said to essentially comprise a first sign portion, a second sign portion, a messaging surface, an interfacing surface, and means for effecting a sign axis of rotation intermediate the first and second sign portions. The first sign portion may comprise or be otherwise associated with a carriage track, which carriage track may be attached to the interfacing surface. The bracket member may essentially comprise a first end and a second end, whereby the first end comprises certain roller means for movement, and which means are cooperatively associated with the carriage track for track-guiding roller movement of the first bracket end. The second end may comprise shaft-engaging structure or gear-engaging structure.

The pinion assembly essentially comprises an actuable pinion member (as at 51) and signal-receiving means for receiving a pinion-actuating signal. The assembly-signaling means function to signal the pinion assembly via the signal-receiving means, and comprise certain signal-detection means for detecting a number of different signals, including power loss and/or power gain signals. The power source is in communication with the pinion assembly and assembly-signaling means for enabling actuation of the pinion member a first direction when a power loss signal is detected by the signal-detection means. The pinion member is cooperable with the geared end of the bracket member (or shaft) for rotating the bracket assembly, which rotating bracket assembly conveys a sign unfolding force along its length and unfolds the first sign portion about the sign axis of rotation via track-guided roller movement of the first bracket end for exposing the messaging surface.

Stated another way, the traffic sign assembly may well function to selectively message onlookers. To achieve this goal, the traffic sign assembly may essentially comprise a sign assembly, a bracket assembly, a pinion assembly, assembly-signaling means, and a power source. The sign assembly comprises a first sign portion, a second sign portion, a messaging surface, and means for effecting a sign axis of rotation intermediate the first and second sign portions. The first sign portion need not be superior to the second sign portion, but, for example, may have a vertical axis of rotation.

The bracket assembly comprises a first bracket end and a second bracket end, whereby the first bracket end is cooperable with the first sign portion for imparting force thereto, and the second bracket end is pinion-actuable. The pinion assembly comprises an actuable member (i.e. a pinion member or shaft member) and signal-receiving means for receiving a pinion-actuating signal. The assembly-signaling means selectively signal the pinion assembly via the signal-receiving means via certain means for detecting power signals and the like. The power source is in communication with the pinion assembly and assembly-signaling means for enabling actuation of the actuable member a first direction when a first power signal is detected and a second direction when a second power signal is detected. The pinion member is cooperable with the second bracket end for actuating the bracket assembly. The actuated bracket assembly unfolds the first sign portion about the sign axis of rotation for exposing the messaging surface for messaging onlookers with a primary message.

Accordingly, although the invention has been described by reference to certain preferred embodiments, it is not intended that the novel assembly be limited thereby, but that modifications thereof are intended to be included as falling within the broad scope and spirit of the following claims and the appended drawings.

I claim:

1. A traffic sign assembly, the traffic sign assembly being unfoldable when activated by a power loss signal for messaging onlookers, the traffic sign assembly comprising:
a bifurcated sign assembly, the sign assembly comprising a top sign portion, a bottom sign portion, an anterior messaging surface, a posterior interfacing surface, and hinge means for effecting a sign axis of rotation intermediate the top and bottom sign portions, the top sign portion comprising a carriage track attached at the interfacing surface;
a J-shaped bracket member, the J-shaped bracket member comprising a head end and a hooked end, the head end comprising roller means for movement, said means being cooperatively associated with the carriage track for track-guiding roller movement of the head end, the hooked end comprising shaft-engaging structure;
a shaft, the shaft comprising a bracket attachment portion and a pinion portion, the bracket attachment portion being coaxially engaged by the shaft-engaging structure thereby forming a shaft-bracket assembly, the shaft-bracket assembly having a uniform assembly axis of rotation;
a linear actuator, the linear actuator comprising an actuable pinion track and signal-receiving means for receiving a track-actuating signal, the shaft and linear actuator being attached to the bottom sign portion via the interfacing surface;
actuator-signaling means for signaling the linear actuator, the actuator-signaling means comprising signal-detection means for detecting power signals; and
an assembly-contained power source, the power source being in communication with the linear actuator and the actuator-signaling means for enabling linear actuation of the pinion track in a first direction when a power loss signal is detected by the signal-detection means, the linear actuated pinion track being cooperable with the pinion portion for rotating the shaft-bracket assembly about the assembly axis of rotation, the rotating shaft-bracket assembly for raising the top sign portion via the bracket member and track-guided roller movement of the head end, the raised top sign portion thereby unfolding from a non-actuated folded state about the sign axis of rotation for exposing the messaging surface, the messaging surface comprising primary indicia for messaging onlookers with a primary message.

2. The traffic sign of claim 1 wherein the actuator-signaling means enable linear actuation of the pinion track in a second direction opposite the first direction when a power gain signal is detected by the signal-detection means, the shaft-bracket assembly for lowering the top sign portion via the bracket member and track-guided roller movement of the head end, the lowered top sign portion thereby folding from an actuated, unfolded state about the sign axis of rotation for concealing the messaging surface.

3. The traffic sign assembly of claim 2 wherein the interfacing surface at the top sign portion comprises secondary indicia, the secondary indicia for messaging onlookers with a secondary message.

4. The traffic sign assembly of claim 3 wherein the primary indicia are cooperatively borne by the top and bottom sign portions, the messaging surface thereby allowing enhanced sizing of the primary indicia, the enhanced sizing for enhancing the primary message to message onlookers.

5. The traffic sign assembly of claim 1 comprising a light emitter and light-signaling means for signaling the light emitter, the light emitter and light-signaling means being in communication with the power source and signal-detection means, the light-signaling means enabling light emission from the light emitter when the power loss signal is detected, the light emission for drawing onlookers' attention toward the messaging surface for enhancing the primary message to message onlookers.

6. The traffic sign assembly of claim 1 comprising a light emitter and light-signaling means for signaling the light emitter, the light emitter and light-signaling means being in communication with the power source and signal-detection means, the light-signaling means enabling light emission from the light emitter when a traffic-governing signal is detected by the signal-detection means, the light emission for drawing onlookers' attention toward the traffic sign assembly and associated traffic signals.

7. The traffic sign assembly of claim 1 wherein the signal-detection means comprise wireless signal-receiving means for receiving wireless power signals.

8. A traffic sign assembly, the traffic sign assembly being unfoldable when activated by a power loss signal for messaging onlookers, the traffic sign assembly comprising:
a sign assembly, the sign assembly comprising a first sign portion, a second sign portion, a messaging surface, an interfacing surface, and means for effecting a sign axis of rotation intermediate the first and second sign portions;
a bracket member, the bracket member comprising first and second bracket ends, the second bracket end comprising shaft-engaging structure;
a shaft, the shaft comprising a bracket-engaging portion and a geared portion, the bracket-engaging portion being engaged by the shaft-engaging structure for forming a uniformly rotational shaft-bracket assembly;
a pinion assembly, the pinion assembly comprising an actuable pinion member and means for receiving a pinion-actuating signal, the shaft and pinion assembly being attached to the second sign portion via the interfacing surface;
assembly-signaling means for signaling the pinion assembly, the assembly-signaling means comprising signal-detection means for detecting power signals; and
a power source, the power source being in communication with the pinion assembly and assembly-signaling means for enabling actuation of the pinion member a first direction when a power loss signal is detected by the signal-detection means, the pinion member being cooperable with the geared portion for rotating the shaft-bracket assembly, the rotating shaft-bracket assembly for unfolding the first sign portion about the sign axis of rotation for exposing the messaging surface, the messaging surface comprising primary indicia for messaging onlookers with a primary message.

9. The traffic sign of claim 8 wherein the assembly-signaling means enable actuation of the pinion member a second direction opposite the first direction when a power gain signal is detected by the signal-detection means for concealing the messaging surface.

10. The traffic sign assembly of claim 8 wherein the interfacing surface at the first sign portion comprises secondary indicia, the secondary indicia for messaging onlookers with a secondary message.

11. The traffic sign assembly of claim 8 wherein the primary indicia are cooperatively borne by the first and second sign portions, the messaging surface thereby allowing enhanced sizing of the primary indicia, the enhanced sizing for enhancing the primary message to message onlookers.

12. The traffic sign assembly of claim 8 comprising a light emitter and light-signaling means for signaling the light emitter, the light emitter and light-signaling means being in communication with the power source and signal-detection means, the light-signaling means enabling light emission from the light emitter when the power loss signal is detected, the light emission for drawing onlookers' attention toward the messaging surface for enhancing the primary message to message onlookers.

13. The traffic sign assembly of claim 8 comprising a light emitter and light-signaling means for signaling the light emitter, the light emitter and light-signaling means being in communication with the power source and signal-detection means, the light-signaling means enabling light emission from the light emitter when a traffic-governing signal is detected by the signal-detection means, the light emission for drawing onlookers' attention toward the traffic sign assembly and associated traffic signals.

14. The traffic sign assembly of claim 8 wherein the signal-detection means comprise wireless signal-receiving means for receiving wireless power signals.

15. The traffic sign assembly of claim 8 wherein the first sign portion comprises a carriage track attached at the interfacing surface, the first bracket end comprising roller means for movement, said means being cooperatively associated with the carriage track for track-guiding roller movement of the first bracket end, the rotating shaft-bracket assembly for unfolding the first sign portion about the sign axis of rotation via track-guided roller movement of the first end for exposing the messaging surface.

16. A traffic sign assembly, the traffic sign assembly for selectively messaging onlookers, the traffic sign assembly comprising:
a sign assembly, the sign assembly comprising a first sign portion, a second sign portion, an anterior messaging surface, and means for effecting a sign axis of rotation intermediate the first and second sign portions;
a bracket assembly, the bracket assembly comprising a first bracket end and a second bracket end, the first bracket end being cooperable with the first sign portion, the second bracket end being pinion-actuable;
a pinion assembly, the pinion assembly comprising an actuable member and signal-receiving means for receiving a pinion-actuating signal; and
assembly-signaling means for signaling the pinion assembly via the signal-receiving means, the assembly-signaling means comprising signal-detection means for detecting power signals; and
a power source, the power source being in communication with the pinion assembly and assembly-signaling means for enabling actuation of the member a first direction when a first power signal is detected via the signal-detection means, the actuable member being cooperable with the second bracket end for actuating the bracket assembly, the actuated bracket assembly for unfolding the first sign portion about the sign axis of rotation for exposing the messaging surface and messaging onlookers with a primary message.

17. The traffic sign of claim 16 wherein the assembly-signaling means enable actuation of the pinion member a second direction when a second power signal is detected via the signal-detection means, the bracket assembly for folding the first sign portion about the sign axis of rotation for concealing the messaging surface.

18. The traffic sign assembly of claim 16 wherein the first sign portion comprises secondary indicia upon a posterior sign surface, the secondary indicia for messaging onlookers with a secondary message.

19. The traffic sign assembly of claim 16 wherein the primary indicia are cooperatively borne by the first and second sign portions, the messaging surface for enhancing sizing of the primary indicia and accentuating the primary message to message onlookers.

20. The traffic sign assembly of claim 16 comprising a light emitter and light-signaling means for signaling the light emitter, the light emitter and light-signaling means being in communication with the power source and signal-detection means, the light-signaling means enabling light emission from the light emitter when the power loss signal is detected, the light emission for drawing onlookers' attention toward the messaging surface for enhancing the primary message to message onlookers.

21. The traffic sign assembly of claim 16 comprising a light emitter and light-signaling means for signaling the light emitter, the light emitter and light-signaling means being in communication with the power source and signal-detection means, the light-signaling means enabling light emission from the light emitter when a traffic-governing signal is detected by the signal-detection means, the light emission for drawing onlookers' attention toward the traffic sign assembly and associated traffic signals.

22. The traffic sign assembly of claim 16 wherein the signal-detection means comprise wireless signal-receiving means for receiving wireless power signals.

23. The traffic sign assembly of claim 16 wherein the first sign portion comprises a carriage track attached at the interfacing surface, the first bracket end comprising roller means for movement, said means being cooperatively associated with the carriage track for track-guiding roller movement of the first bracket end, the rotating shaft-bracket assembly for unfolding the first sign portion about the sign axis of rotation via track-guided roller movement of the first end for exposing the messaging surface.
